(19) United States
(12) Patent Application Publication
(10) Pub. No.: US 2009/0214735 A1
(43) Pub. Date: Aug. 27, 2009

(54) Process for Puffing-Drying Fruits and Vegetables

(75) Inventor: Shuxun Wu, Hebei Province (CN)

Correspondence Address: THE WEBB LAW FIRM, P.C., 700 KOPPERS BUILDING, 436 SEVENTH AVENUE, PITTSBURGH, PA, 15219, US

(73) Assignee: Baomin Zhao, Beijing (CN)

(21) Appl. No.: 12/159,254

(22) PCT Filed: Dec. 13, 2006
(86) PCT No.: PCT/CN2006/003388

§ 371 Date: Oct. 27, 2008

(30) Foreign Application Priority Data
Dec. 26, 2005 (CN) 200510048226.X

(51) Int. Cl. A23L 1/212

(52) U.S. Cl. 426/445

(57) ABSTRACT

A process for puffing-drying fruit-vegetable foods at normal temperature. The process includes removing the free water from fruits and vegetables which have been washed, then put the fruits and vegetables into a reaction vessel, and vacuumizing the reaction vessel to 0.08-0.1 MPa, injecting carbon dioxide to 1.5-10.5 MPa, maintaining 30 seconds to 60 minutes, depressurizing to atmospheric pressure over 0.5-4 minutes so as to puff-dry the materials.

### FIELD OF THE INVENTION

The present invention relates to the dehydration technique for food preservation. More specially, the present invention relates to the process for puffing-drying fruit-vegetable foods.

### BACKGROUND OF THE INVENTION

The production technique of puffing and drying fruit-vegetable foods is always carried out as an effective method in the field of food (even including medicine) processing. Through puffing-drying process, the puffed products always have prolonged shelf-life and better taste, and they are convenient for transporting. But in conventional process, high temperature, high strength extrusion and deep-frying process are used. These destroy the nutrients contents of the food and reduce the quality of color, flavor, taste and rehydration. Sometimes it may result in several times increase of carcinogenic substances (such as acryl amide). Not to mention that flying is not suitable for many fruits and vegetables treatments.

Another drying technique is freezing vacuum drying (−30° C.), which is recognized as an effective food drying process to keep the final products with good taste, excellent appearance and good rehydration property. However due to its high cost of processing and high price of the final products (for example, the price of freezing dried spinach is 148 Yuan per kilo gram), they can't be used as general merchandise. They are only provided for the use of special type of work and corps, such as spaceflight or navigation fields.

### SUMMARY OF THE INVENTION

To overcome the defections said above of the process, such as the loss of the nutrients, poor flavor, taste and color, low rehydration quality, poisonous and etc., or no popularization value for the high cost of the process, the present invention provides a process for puffing-drying fruit-vegetable foods at the normal temperature.

In this invention, a new dehydration process, through which the foods are puffed and dried with carbon dioxide at normal temperature, is accomplished successfully. On the one hand, through his process, the maximum of nutrients of the fruits and vegetables are kept and the foods have good property of flavor and taste after being rehydrated. On the other hand, the cost of equipments and the cost of various conditions are low, the operation is easy to grasp, and it is suitable for many fruits and vegetables. These make it possible that the process can be accomplished in the industry and the products can have great market potential (the cost of this process is about one fifth to one tenth of the cost of vacuum freezing drying).

To achieve the objectives mentioned above, it is necessary to find out a substance which must be nontoxic, tasteless and non-pollution, to enter into the fruits and vegetables cells to combine with interstitial water or bound water therein at room temperature firstly. It also requires that the substance can rapidly release water to puff-dry the fruits and vegetables when necessary. Carbon dioxide is found to be suitable after many years research.

Carbon dioxide is colorless, tasteless, non-toxic, non-pollution, low cost and easily obtained. Under suitable pressure, its solubility inside and outside the plant cell is greatly improved. When the pressure is removed, it can be released rapidly with the water. As a result, good puffing effect of the materials can be achieved when they are dehydrated.

Said process for puffing-drying fruit-vegetable foods at normal temperature of present invention, includes removing the free water from the washed fruits and vegetables, putting the fruits and vegetables into a reaction vessel, and vacuumizing the reaction vessel to 0.08-0.1 MPa, injecting carbon dioxide to 1.5-10.5 MPa, maintaining 30 seconds to 60 minutes, depressurizing to atmospheric pressure in the period of 0.5-4 minutes so as to puff-dry the materials. Wash the fruits and vegetables and dehydrate them through conventional dehydration methods to make the water content of them to be 20-60% before put them into the reaction vessel. Another feature of present invention is that the final water content of fruits and vegetables is 3-5% after they are depressurized to atmospheric pressure. Then the foods are vacuum-packed. The pressure of the packing vessel is 0.05-0.1 MPa. Said reaction vessel is puffing-drying reaction vessel for fruit-vegetable foods. Said depressurizing the pressure to atmospheric pressure in the period of 0.5-4 minutes is that the pressure is depressurized step by step for at least 1-3 times to decrease the pressure of the vessel to atmospheric pressure.

The prominent substantive features and notable progress of present invention are mentioned below.

1. Since the carbon dioxide used by present invention is non-toxic, tasteless, colorless and non-pollution, the present invention can avoid bringing the toxicants and the pollution to the environment and fruits and vegetables.

2. The original taste and color of the fruits and vegetables are not affected by the puffing-drying process in which the carbon dioxide is used at normal temperature. The loss of the nutrients of fruits and vegetables are lessened. The products have beautiful appearance with good taste. And they are crisp and delicious.

3. The products have good rehydration performance.

4. The cost of the equipments and the cost of the process are reasonable. The process is easy to operate.

5. The price of the final products is only ⅕- 1/10 to the price of the products of vacuum freezing drying. It means that the final products have strong market competitive ability.

6. Due to its high quality and low cost, the products are especially suitable for the application in the places where green vegetables and fresh fruits are scarce, such as alpine region, frontier, army, steamboat and so on. The product served as delicious snack food is also suitable for the application in the ordinary families.

7. The process has a wide application range. It is suitable for fruits (apple, pear, jujube, banana, cantaloupe and so on) and vegetables (carrot, white radish, red radish, shallot ginger, mushroom, beans and so on).

8. The development of this process is especially suitable for the further processing of the agriculture byproducts of the fruit growers and vegetable farmers. It has enormous economic and social benefits.

### DETAILED DESCRIPTION OF THE INVENTION

The specific implementation examples are described in details as follows.

### Example 1

### Crisp Jujube

Remove the nuclear from the fresh jujubes and wash them. Put the jujubes in the oven to remove the free water to make the water content to be 20-60%. Then put them into puffing-drying reaction vessel for fruit-vegetable foods. Vacuumize the reaction vessel to 0.08-0.1 MPa. Then inject CO₂ to the vessel to 1.5-9.5 MPa. Maintain 5-30 minutes. Depressurize the pressure of the vessel to atmospheric pressure rapidly (within 0.5-2 minutes) to puff-dry the jujubes. Specific operating parameters are showed in table 1.

TABLE 1
the condition of puffing-drying crisp jujubes

| | The water | The pressure of | | The time of |
|---|---|---|---|---|
| | content of jujubes | vessel before | The pressure of | dehydration after |
| Sequence | after their free | CO₂ is injected, | reactor after CO₂ | CO₂ is injected, |
| number | water is removed | MPa | is injected, MPa | min |
| 1 | 20% | 0.08 | 1.8 | 8 |
| 2 | 30% | 0.09 | 3.5 | 15 |
| 3 | 40% | 0.1 | 6 | 10 |
| 4 | 60% | 0.09 | 8 | 25 |

There is little water on the surface of the jujubes when they are taken out. Put the Jujubes into oven in order to remove the surface water. Then take them out from the oven and vacuum pack them (at the pressure of 0.05-0.1 MPa). Compared with the crisp jujubes obtained by conventional technology, the nutritional components (Vitamins, proteins, polysaccharides, pectin) of jujubes produced by this process are well preserved. These jujubes are crisp. They have the flavor of fresh jujubes. Their colors are bright (especially the flesh). And they have no greasy taste of fried jujube and even no harmful components, such as acrylic amide.

### Example 2

### Crisp Apple Slice

Slice up the apples and wash them. Put them into the oven for about 10-30 minutes to remove the free water. The water content of the sliced apples decreases to 20-50%. Then put the sliced apples into puffing-drying reaction vessel for fruit-vegetable foods. Vacuumize the reaction vessel to 0.08-0.1 MPa. Then inject CO₂ into the vessel to 1.5-8 MPa. Maintain 3-20 minutes. Depressurize the pressure of the vessel to atmospheric pressure rapidly (within 1-3 minutes) to puffy-dry the sliced apples. Specific operating parameters are showed in table 2.

TABLE 2
the condition of puffing and drying crisp apple slice

| | The water content | The pressure of | The pressure of | |
|---|---|---|---|---|
| | of the crisp apples | the vessel | the vessel after | The time of |
| Sequence | after their free | before CO₂ is | CO₂ is injected, | dehydration after |
| number | water is removed | injected, MPa | MPa | CO₂ is injected, min |
| 1 | 20% | 0.08 | 1.8 | 3 |
| 2 | 30% | 0.09 | 3.5 | 15 |
| 3 | 40% | 0.1 | 6 | 10 |
| 4 | 50% | 0.09 | 8 | 18 |

Take the apples out from the vessel and put them into the oven to remove the surface water. Then take them out from the oven and vacuum-pack them (at the pressure of 0.05-0.1 MPa). The nutritional components of apples are well preserved. The apple slices are very crisp. They have the flavor of fresh apple. The defection of weak taste and hard drying of ordinary dried apple doesn't exist in these apple slices, let alone the greasiness flavor and rancidity of the vacuum fried dried apples.

### Example 3

### Red Radish Crisp (Strip)

Cut the red radishes into crisps (or strips) and rinse them by water. Put them into the oven for about 10-30 minutes to remove the free water. The water content of sliced apples decreases to 20%-60%. Then put the sliced happy radishes into the puffing-drying reaction vessel. Vacuumize the reaction vessel to 0.08-0.1 MPa. Inject CO₂ into the vessel to 1.5-7 MPa. Maintain 2-20 minutes. Depressurize the pressure of the vessel to atmospheric pressure rapidly (within 2-4 minutes) to puff-dry the sliced red radishes. Specific operating parameters are showed in table 3.

TABLE 3
the condition of puffing-drying red radish crisp (strip):

| | The water content | The pressure of | The pressure of | |
|---|---|---|---|---|
| | of sliced radishes | the vessel | the vessel after | The time of |
| Sequence | after their free | before CO₂ is | CO₂ is injected, | dehydration after |
| number | water is removed | injected, MPa | MPa | CO₂ is injected, min |
| 1 | 20% | 0.08 | 1.8 | 3 |
| 2 | 30% | 0.09 | 3.5 | 12 |
| 3 | 40% | 0.1 | 5 | 9 |
| 4 | 60% | 0.09 | 7 | 18 |

Take the radishes out from the vessel and put them into oven to remove the surface water. Then take them out from the oven and vacuum-pack them (at the pressure of 0.05-0.1 MPa). When the products are rehydrated, their color is more brilliant and more beautiful than the raw materials. The products have good rehydration ability. The flavor of the red radish crisp is stronger and the nutritional components are well preserved.

1-8. (canceled)

9: A process for puffing-drying fruit-vegetable foods at normal temperature, comprising: rinsing the fruit-vegetable foods and removing the surface water; then putting the foods into the reaction vessel; vacuumizing the reaction vessel to 0.08-0.1 MPa; then injecting CO₂ to the vessel to 1.5-10.5 MPa; maintaining 0.5-60 minutes; depressurizing the pressure to atmospheric pressure over 0.5-4 minutes to puff and dry the foods.

10: The process for puffing-drying fruit-vegetable foods at normal temperature as described in claim 9, wherein, before putting the fruit-vegetable foods into the reaction vessel, rinsing them and removing the free water to make the water contents of the foods to be 20-60% through traditional drying technology.

11: The process for puffing-drying fruit-vegetable foods at normal temperature as described in claim 9, wherein, after depressurizing the pressure of the vessel with foods to atmospheric pressure, dehydrating the fruit-vegetable foods to make the water contents of the foods to be 3-5%; then vacuum-packing the foods, and the pressure of the packing vessel is 0.05-0.1 MPa.

12: The process for puffing-drying fruit-vegetable foods at normal temperature as described in claim 9, wherein said reaction vessel is a puffing-drying reaction vessel for fruit-vegetable foods.

13: The process for puffing-drying fruit-vegetable foods at normal temperature as described in claim 9, wherein said depressurizing the pressure to atmospheric pressure over 0.5-4 minutes is that the pressure is decreased step by step for at least 1-3 times to depressurize the pressure of the vessel to atmospheric pressure.

14: The process for puffing-drying fruit-vegetable foods at normal temperature as described in claim 9, wherein, the pressure of the vessel is increased to 1.5-9.5 MPa; the pressure is maintained for 5-30 minutes; and the vessel is depressurized to atmospheric pressure over 0.5-2 minutes to puff-dry the foods.

15: The process for puffing-drying fruit-vegetable foods at normal temperature as described in claim 9, wherein the pressure of the vessel is increased to 1.5-8 MPa; the pressure is maintained for 3-20 minutes; and the vessel is depressurized to atmospheric pressure over 1-3 minutes to puff-dry the foods.

16: The process for puffing-drying fruit-vegetable foods at normal temperature as described in claim 9, wherein the pressure of vessel is increased to 1.5-7 MPa; the pressure is maintained for 2-20 minutes; and the vessel is depressurized to atmospheric pressure over 2-4 minutes to puff-dry the foods.
